(19) United States
(12) Patent Application Publication
(10) Pub. No.: US 2026/0349492 A1
(43) Pub. Date: Nov. 5, 2026

(54) SUSTAINABLE DYNAMIC VOLTAGE CONTROL FOR COMPONENTS

(71) Applicant: INTERNATIONAL BUSINESS MACHINES CORPORATION, ARMONK, NY (US)

(72) Inventors: SAMUEL SAGAN, BEACON, NY (US); JOHN S. WERNER, FISHKILL, NY (US); RAFAELA FROTA WHALEN, ARLINGTON, NY (US); FAEZEH GHOLAMI, RIDGEWOOD, NJ (US)

(21) Appl. No.: 19/195,130

(22) Filed: Apr. 30, 2025

(51) Int. Cl. G06F 1/28; G06F 1/3215; G06F 1/3234

(52) U.S. Cl. CPC G06F 1/28; G06F 1/3215; G06F 1/3253

(57) ABSTRACT

A method for sustainable dynamic voltage control for components according to an example includes outputting, from a plurality of voltage regulators on a circuit board to a plurality of electrical components on the circuit board, regulated output voltages. The method includes receiving, by a microcontroller on the circuit board, environmental information and error information. The method includes individually adjusting, by the microcontroller based on the environmental information and the error information, the regulated output voltages output by the voltage regulators.

### BACKGROUND

The present disclosure relates to methods, apparatus, and products for sustainable dynamic voltage control for components.

### SUMMARY

According to embodiments of the present disclosure, various methods, apparatus and products for sustainable dynamic voltage control for components are described herein. In some aspects, sustainable dynamic voltage control for components includes outputting, from a plurality of voltage regulators on a circuit board to a plurality of electrical components on the circuit board, regulated output voltages. A microcontroller on the circuit board receives environmental information and error information. The microcontroller individually adjusts, based on the environmental information and the error information, the regulated output voltages output by the voltage regulators.

### BRIEF DESCRIPTION OF THE DRAWINGS

FIG. 1 sets forth an example computing environment according to aspects of the present disclosure.

FIG. 2 sets forth an example computing system with sustainable dynamic voltage control for components according to aspects of the present disclosure.

FIG. 3 sets forth a flowchart of an example method for sustainable dynamic voltage control for components according to aspects of the present disclosure.

FIG. 4 sets forth a flowchart of an example method for sustainable dynamic voltage control for components according to further aspects of the present disclosure.

### DETAILED DESCRIPTION

In general, a voltage regulator is a circuit that is designed to maintain a constant output voltage level as operating conditions change over time. That is, the voltage regulator may be an electronic device or system designed to receive an input voltage and automatically maintain a constant voltage level on one or more output terminals. Depending on the design, a voltage regulator can be used to regulate one or more alternating current (AC) or direct current (DC) voltages. Voltage regulators can be included in electronic devices such as, for example, computer power supplies where they can be used to stabilize DC voltages used to supply power to electronic components such as processor(s), memory devices, and other types of integrated circuits (ICs). Voltage regulators may also be included on input/output (I/O) cards of a computing system to supply power to electronic components on the card, such as various Peripheral Component Interconnect Express (PCIe) components.

In electronics, individual components may operate within a wide range of voltages. The operating voltage level of individual components may be set by designers at the mid-range point and left unchanged for the lifetime of the component. At different workloads and due to varying environmental circumstances, this can lead to wasted power since the voltage is set higher than needed for a particular function or application. In other instances, voltages are set lower than required for a particular function or application yielding a higher error rate. For example, a particular switch on an I/O card may be able to operate within a range of voltages (e.g., 0.7V 0.9V). The switch may receive power from a voltage regulator controlled by a microcontroller that sets the operating voltage for the regulator. In some cases, a designer may set the operating voltage to 0.8V, the mid-range point for the switch, for the lifetime of the switch's operational use. However, this may lead to more power being used by the I/O card than necessary for this particular switch. The same may be true for many other components on the I/O card, such as switches, retimers, optical modules, and other components.

Some examples disclosed herein are directed to sustainable dynamic voltage control for components via a microcontroller. Some examples disclosed herein vary the voltage provided to components on a printed circuit board (e.g., I/O card) to provide a sustainable mode of operation. Some examples dynamically adjust the power levels provided to the components to improve sustainability. Some examples are directed to a method to minimize power consumption while maintaining sufficient performance, function, or application of components within a system or sub-system by extrapolating the necessary optimal voltage from current environmental factors and operational needs (e.g., variation in silicon, workload, etc.). Inherent differences in components, such as silicon differences, can lead to a need for different voltage setpoints for the components. In some examples, current environmental circumstances and the card's operational needs are analyzed to determine what the operational voltage of the particular component under a specific repetitive and predictable workload, in a predictable environmental condition could be set to (e.g., 0.75V) within the acceptable range of tolerance needed to satisfy a particular application use case (e.g., light workload, client usage, etc.). Alternatively, a similar approach may occur if a heavier workload was needed. In this case, the operational voltage may be set to 0.85V to reduce system errors.

Some examples disclosed herein are directed to a method executed by a sustainable dynamic voltage module for determining optimal voltages for electrical components to minimize power while maintaining sufficient performance by considering environmental conditions, variation in silicon, and workload. In some examples, real-time environmental data, static silicon data, and workload data are collected. Selective voltage binning or AI/data science models may be used to output an optimal voltage for a given electrical component based on the collected data and operational needs. Instant or timed voltage adjustments may be performed to optimize power consumption and adjust voltage setpoints to one or more electrical components based on the selective voltage binning or AI/data science model output.

An apparatus may include the sustainable dynamic voltage module, which may be located on a card microcontroller or system control unit. In some examples, utilization, temperature, humidity, correctable errors, and/or signal integrity parameters that may impact the required voltage settings for unique operational needs are monitored to determine threshold settings intended to optimize performance. In some examples, the AI model may be a clustering or reward-based system that increases scores for alterations in voltage under given conditions that do not increase system errors and decreases scores for alterations in voltages under given conditions that increase system errors.

An example of the present disclosure is directed to a method, which includes outputting, from a plurality of voltage regulators on a circuit board to a plurality of electrical components on the circuit board, regulated output voltages. The method includes receiving, by a microcontroller on the circuit board, environmental information and error information. The method includes individually adjusting, by the microcontroller based on the environmental information and the error information, the regulated output voltages output by the voltage regulators.

In some examples, the method further includes receiving, by the microcontroller, component utilization information; and individually adjusting, by the microcontroller based on the environmental information, the error information, and the component utilization information, the regulated output voltages output by the voltage regulators.

In some examples of the method, the error information includes a number of correctable errors that occur over a predetermined period of time and are attributable to the electrical components. In some examples, the method further includes determining that the number of correctable errors that occur over the predetermined period of time exceeds a threshold number; and increasing, by the microcontroller based on the determining, the regulated output voltage output by one or more of the voltage regulators.

In some examples of the method, the microcontroller individually adjusts the regulated output voltages based on one or both of a lookup table and an artificial intelligence (AI) model. In some examples, the AI model increases scores for voltage alterations that do not increase correctable errors and decreases scores for voltage alterations that increase correctable errors.

In some examples of the method, the circuit board is an input/output (I/O) card of a computing system. In some examples of the method, the environmental information includes temperature information and humidity information. In some examples of the method, the electrical components are Peripheral Component Interconnect Express (PCIe) components, and include one or more of an optical module component, a retimer component, and a switch component.

Another example of the present disclosure is directed to a computer system, which includes a processor set. The computer system includes a circuit board including a plurality of voltage regulators to output regulated output voltages to a plurality of electrical components on the circuit board. The computer system includes one or more computer-readable storage media. The computer system includes program instructions stored on the one or more storage media to cause the processor set to perform operations, which include receiving environmental information and error information. The operations further include individually adjusting, based on the environmental information and the error information, the regulated output voltages output by the voltage regulators.

In some examples of the computer system, the operations further include receiving component utilization information; and individually adjusting, based on the environmental information, the error information, and the component utilization information, the regulated output voltages output by the voltage regulators.

In some examples of the computer system, the error information includes a number of correctable errors that occur over a predetermined period of time and are attributable to the electrical components. In some examples, the operations further include determining that the number of correctable errors that occur over the predetermined period of time exceeds a threshold number; and increasing, based on the determining, the regulated output voltage output by one or more of the voltage regulators.

In some examples of the computer system, the regulated output voltages are individually adjusted based on one or both of a lookup table and an artificial intelligence (AI) model. In some examples, the AI model increases scores for voltage alterations that do not increase correctable errors and decreases scores for voltage alterations that increase correctable errors.

In some examples of the computer system, the circuit board is an input/output (I/O) card of the computer system. In some examples of the computer system, the environmental information includes temperature information and humidity information. In some examples of the computer system, the electrical components are Peripheral Component Interconnect Express (PCIe) components, and include one or more of an optical module component, a retimer component, and a switch component.

Another example of the present disclosure is directed to a computer program product, which includes one or more computer-readable storage media. The computer program product includes program instructions stored on the one or more storage media to perform operations, which include controlling a plurality of voltage regulators on a circuit board to output a plurality of regulated output voltages to a plurality of electrical components on the circuit board. The operations further include receiving environmental information and error information. The operations further include individually adjusting, based on the environmental information and the error information, the regulated output voltages output by the voltage regulators.

In some examples of the computer program product, the operations further include receiving component utilization information; and individually adjusting, based on the environmental information, the error information, and the component utilization information, the regulated output voltages output by the voltage regulators.

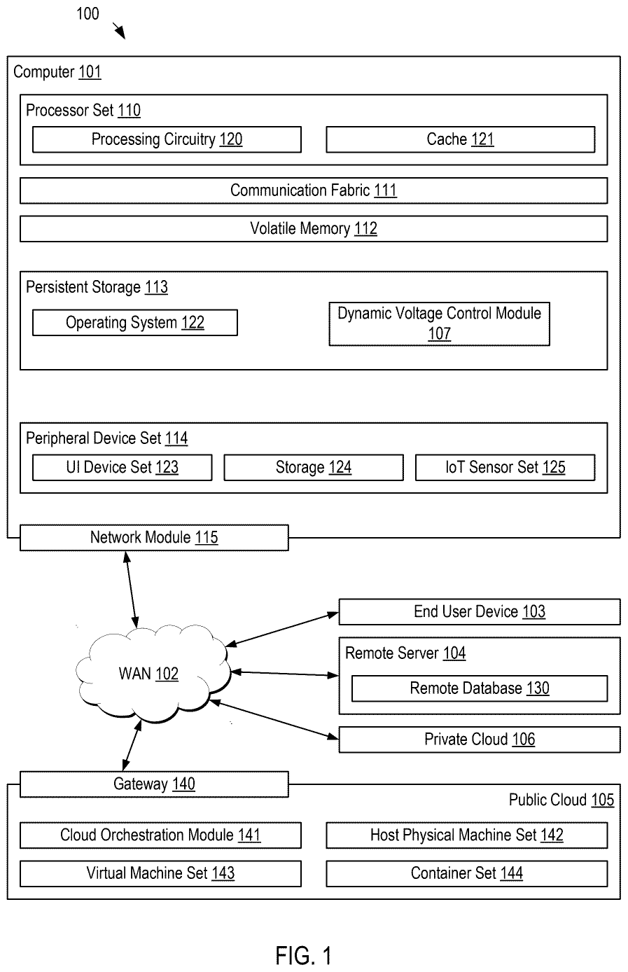

FIG. 1 sets forth an example computing environment according to aspects of the present disclosure. Computing environment 100 contains an example of an environment for the execution of at least some of the computer code involved in performing the various methods described herein, such as dynamic voltage control module 107. In addition to dynamic voltage control module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic voltage control module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in dynamic voltage control module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in dynamic voltage control module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

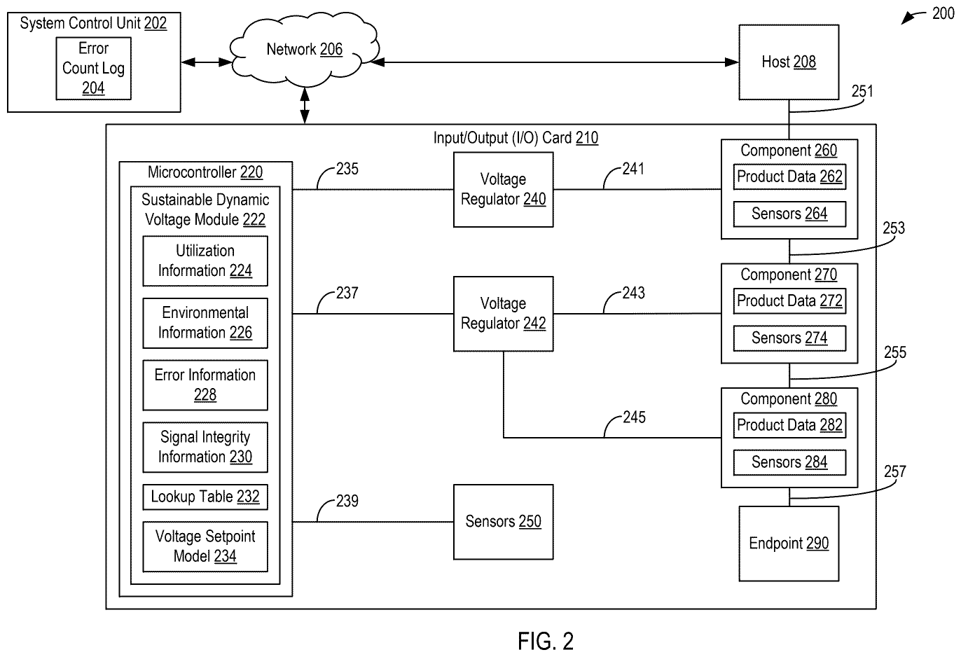

FIG. 2 sets forth an example computing system 200 with sustainable dynamic voltage control for components according to aspects of the present disclosure. Computing system 200 may implement some or all of the functionality of dynamic voltage control module 107 (FIG. 1). Computing system 200 includes system control unit 202, network 206, host 208, and I/O card 210. System control unit 202 includes error count log 204. I/O card 210 includes microcontroller 220, voltage regulators 240 and 242, sensors 250, components 260, 270, and 280, and endpoint 290.

System control unit 202 is communicatively coupled to host 208 and I/O card 210 via network 206. Host 208 is communicatively coupled to components 260, 270, and 280, and endpoint 290, via communication links 251, 253, 255, and 257, which may be a PCIe communication bus in some examples. Microcontroller 220 is communicatively coupled to voltage regulators 240 and 242 via communication links 235 and 237, respectively, which may be an I2C communication bus in some examples. Microcontroller 220 is coupled to sensors 250 via communication link 239. Voltage regulator 240 provides power (e.g., a regulated output voltage) to component 260 via communication link 241. Voltage regulator 242 provides power (e.g., a regulated output voltages) to components 270 and 280 via communication links 243 and 245, respectively. In some examples, endpoint 290 may be a connector or another component. In some examples, components 260, 270, and 280 are PCIe components, and the components may include, for example, an optical module component, a retimer component, a switch component, or other components. Although the illustrated example includes two voltage regulators 240 and 242, other examples may include more or less than two voltage regulators. Also, although the illustrated example includes three components 260, 270, and 280, other examples may include more or less than three components.

Microcontroller 220 includes a sustainable dynamic voltage module 222. In other examples, system control unit 202 may include some or all of the sustainable dynamic voltage module 222, or the sustainable dynamic voltage module 222 may be included in a memory (e.g., EPROM) on the I/O card 210. In some examples, sustainable dynamic voltage module 222 implements some or all of the functionality of dynamic voltage control module 107 (FIG. 1). The sustainable dynamic voltage module 222 includes utilization information 224, environmental information 226, error information 228, signal integrity information 230, lookup table 232, and voltage setpoint model 234. Component 260 includes product data 262 and sensors 264. Component 270 includes product data 272 and sensors 274. Component 280 includes product data 282 and sensors 284.

Microcontroller 220 monitors utilization of each of the components 260, 270, and 280, which is represented by utilization information 224. Microcontroller 220 monitors sensed environmental information (e.g., temperature and humidity) for components 260, 270, and 280, and I/O card 210, which is represented by environmental information 226. Microcontroller 220 monitors error information (e.g., correctable errors or CEs) attributable to the components 260, 270, and 280, which is represented by error information 228. Microcontroller 220 monitors signal integrity information for components 260, 270, and 280, which is represented by signal integrity information 230. Microcontroller 220 may also monitor any other parameters that may impact the voltage settings of the regulated output voltages provided to components 260, 270, and 280. The microcontroller 220 may monitor any one or a combination of these parameters. Some of these parameters may be provided to the microcontroller 220 from one or more sensors, including sensors 264, 274, and 284 on a component level and/or other sensors 250 on a card level.

In some examples, system control unit 202 monitors correctable errors that are attributable to the components 260, 270, and 280. System control unit 202 maintains an error count log 204, which may include individual correctable error counts for each of the components 260, 270, and 280. A correctable error count for a given component indicates the number of correctable errors that occurred during a predetermined period of time and are attributable to that component. System control unit 202 communicates the error count log 204 to microcontroller 220, which may store some or all of the information as error information 228. In other examples, components 260, 270, and 280 may communicate their respective correctable error counts directly to microcontroller 220. Thus, error information is actively fed back to the microcontroller 220, which may monitor the correctable errors and cause an increase in one or more of the regulated output voltages output by voltage regulators 240 and 242 if the number of correctable errors in a predetermined period of time exceeds an error threshold.

In some examples, microcontroller 220 actively minimizes the voltage provided to one or more of the components 260, 270, and 280 based on performance (e.g., based on error information 228), and also takes into account utilization information 224, environmental information 226, signal integrity information 230, and product data 262, 272, and 282. Microcontroller 220 may dynamically check the performance of each of the components 260, 270, and 280 and reduce the voltages provided to these components as low as possible without adversely impacting performance.

In some examples, microcontroller 220 uses run-time environment data and static silicon data to utilize selective voltages binning. These examples may be implemented via lookup table 232, which may be stored on the microcontroller 220 or a memory on the I/O card 210. In some examples, the lookup table 232 includes card specific content (e.g., vital product data (VPD)) and environmental conditions. In some examples, components 260, 270, and 280 include product data 262, 272, and 282, respectively, which may be incorporated into the lookup table 232. The product data 262, 272, and 282 may include voltage requirements of the respective components. The lookup table 232 may be generated at the factory when initial voltage setpoints for the components 260, 270, and 280 are determined. The contents of the lookup table 232 may be determined though lab testing.

In other examples, microcontroller 220 may use a voltage setpoint model 234, which may be an AI/data science model that takes the information discussed above (e.g., utilization information 224, environmental information 226, error information 228, signal integrity information 230, and product data 262, 272, and 282) as inputs, and outputs voltage setpoints based on historical monitoring trends. In some examples, the voltage setpoint model 234 bins the monitored data into groups to generate a histogram. Some examples may involve performing AI clustering, where all inputs mentioned above are put in a vector, and the vector is used to locate the closest cluster. The identified cluster has voltage setpoints that have historically worked well under similar conditions. The AI model and history data may include card specific content (e.g., VPD) and environmental conditions. In some examples, the product data 262, 272, and 282 may be incorporated into the voltage setpoint model 234. Manufacturing test of corner voltage cases may be used for training data for training voltage setpoint model 234. The trained machine learning model outputs optimum voltage values for each of the components 260, 270, and 280 based on the inputs discussed above. In some examples that perform AI inferencing, the voltage setpoint model 234 may be moved off of the microcontroller 220 due to the size of the model 234 and/or the inputs provided to the model 234 (e.g., workload).

Microcontroller 220 uses the output of one or both of the lookup table 232 and the voltage setpoint model 234 to individually determine, for each of the components 260, 270, and 280, a regulated output voltage level to be provided to that component. Microcontroller 220 then controls the voltage regulators 240 and 242 to provide the determined regulated output voltage levels to the components. The process for adjusting the voltages provided to the components 260, 270, and 280 may be repeated on a periodic basis to continually update voltages as workload, environment, and other factors change over an established period of time. The voltage adjustments may include instant and/or timed adjustments. A select period of time may be identified to not jeopardize the performance of any one component (e.g., voltage adjustment ramps slowly over a one-minute period). Voltage adjustments may be made on the order of once per second, for example. In some examples, voltages provided to the components 260, 270, and 280 may be changed a few times a day (e.g., peak usage, nighttime when utilization is lower, etc.). In some examples, the components 260, 270, and 280 need not be taken down/offline during the voltage adjustment.

Microcontroller 220 monitors correctable errors and causes an adjustment in one or more of the regulated output voltages output by voltage regulators 240 and 242 if an error threshold is exceeded that indicates that the voltage should be adjusted. The error threshold may be set lower than the failure/degrade criteria (e.g., 5 CEs in 1 minute). Some examples may use component feedback (CE's, Figure of Merit (FoM)) to determine if a change was good or further change is possible. In some examples, eye measurements may be computed on the components 260, 270, and 280. If the error threshold is exceeded, the microcontroller 220 causes an increase in the regulated output voltage provided to one or more of the components 260, 270, and 280, and uses this as training data for the voltage setpoint model 234 or to update the lookup table 232. In some examples, microcontroller 220 tracks how often a voltage setting was increased for a predicted input and only updates lookup table 232 if a count threshold is exceeded. If the threshold is not exceeded, microcontroller 220 may cause a decrease in the regulated output voltage if such a decrease has not yet been attempted under similar conditions. If the threshold is not exceeded, microcontroller 220 may record the good settings as another data point for the AI model learning, then loop back to continue monitoring and making voltage adjustment decisions.

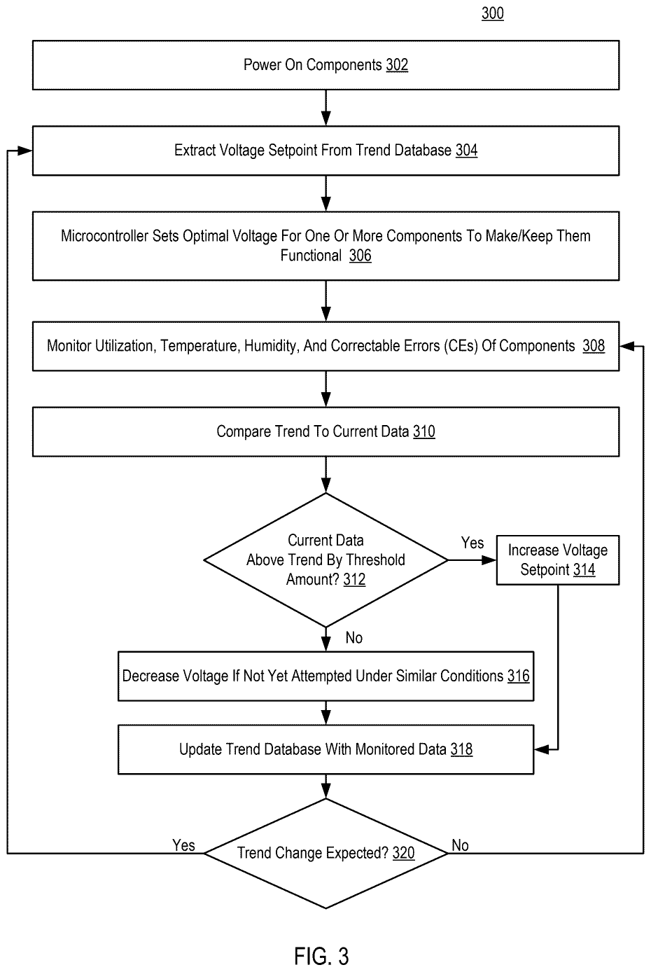

FIG. 3 sets forth a flowchart of an example method 300 for sustainable dynamic voltage control for components according to aspects of the present disclosure. In a particular embodiment, the method 300 is performed utilizing computing system 200 (FIG. 2). The method 300 includes powering on 302 components. In some examples, components 260, 270, and 280 may be powered on at 302 in method 300. The method 300 includes extracting 304 a voltage setpoint from a trend database. The trend database may include one or both of the lookup table 232 and the voltage setpoint model 234. The trend database may either be a static database or a database that is updated over time based on usage. The method 300 includes setting 306, by a microcontroller, an optimal voltage for one or more components to make/keep them functional. In some examples, microcontroller 220 sets the optimal voltage at 306 by causing one or both of the voltage regulators 240 and 242 to provide a regulated output voltage that corresponds to the voltage setpoint extracted at 304.

Method 300 includes monitoring 308 utilization, temperature, humidity, and correctable errors of components. In some examples, microcontroller 220 performs the monitoring 308. Method 300 includes comparing 310 the trend to the current data obtained from the monitoring at 308. In some examples, microcontroller 220 performs the comparing 310. Method 300 includes determining at 312 whether the current data (e.g., error data) is above the trend by a threshold amount. In some examples, microcontroller 220 performs the determination at 312. If it is determined at 312 that the current data is above the trend by the threshold amount, the method 300 moves to 314 to increase the voltage setpoint, and then the method 300 moves to 318. In some examples, microcontroller 220 increases the voltage setpoint at 314 by increasing the voltage setpoint of one of the voltage regulators 240 or 242, which causes an increase in the regulated output voltage provided by that voltage regulator to the component or components connected to the voltage regulator.

If it is determined at 312 that the current data (e.g., error data) is not above the trend by the threshold amount, the method 300 moves to 316 to decrease the voltage setpoint if such a decrease has not yet been attempted under similar conditions, and then the method 300 moves to 318. In some examples, microcontroller 220 decreases the voltage setpoint at 316 by decreasing the voltage setpoint of one of the voltage regulators 240 or 242, which causes a decrease in the regulated output voltage provided by that voltage regulator to the component or components connected to the voltage regulator. Method 300 includes updating 318 the trend database with the monitored data (obtained at 308). In some examples, microcontroller 220 performs the updating 318.

Method 300 includes determining at 320 whether a trend change is expected. In some examples, microcontroller 220 performs the determination at 320. For example, microcontroller 220 may determine that certain times of the day have higher utilization/workloads, and may set the voltages higher during this period with less frequent checks on whether the voltages can be lowered. At other times of the day, a trend may indicate that more frequent voltage checks may be performed and there may be more opportunities to lower the voltages. If it is determined at 320 that a trend change is not expected, the method 300 returns to 308. If it is determined at 320 that a trend change is expected, the method 300 returns to 304.

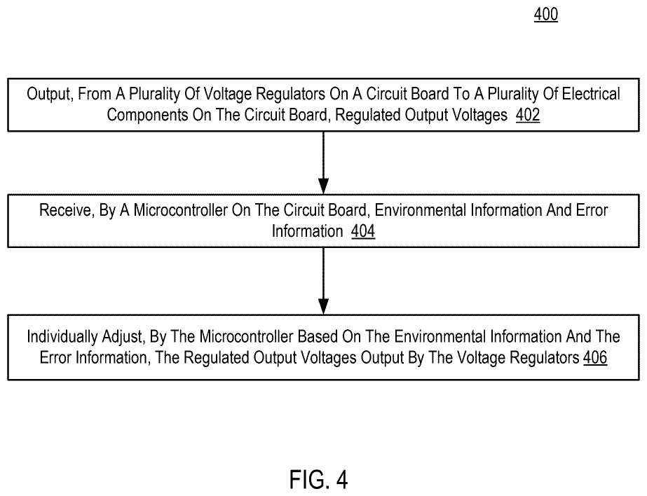

FIG. 4 sets forth a flowchart of an example method 400 for sustainable dynamic voltage control for components according to further aspects of the present disclosure. In a particular embodiment, the method 400 is performed utilizing computing system 200 (FIG. 2). The method 400 includes outputting 402, from a plurality of voltage regulators on a circuit board to a plurality of electrical components on the circuit board, regulated output voltages. The method 400 includes receiving 404, by a microcontroller on the circuit board, environmental information and error information. The method 400 includes individually adjusting 406, by the microcontroller based on the environmental information and the error information, the regulated output voltages output by the voltage regulators.

Some examples disclosed herein gain an understanding of workloads and environmental conditions and adjust voltages provided to components to match this understanding and provide a more sustainable, environmentally conscious, and power conservative mode of operation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
outputting, from a plurality of voltage regulators on a circuit board to a plurality of electrical components on the circuit board, regulated output voltages;
receiving, by a microcontroller on the circuit board, environmental information and error information; and
individually adjusting, by the microcontroller based on the environmental information and the error information, the regulated output voltages output by the voltage regulators.

2. The method of claim 1, and further comprising:
receiving, by the microcontroller, component utilization information; and
individually adjusting, by the microcontroller based on the environmental information, the error information, and the component utilization information, the regulated output voltages output by the voltage regulators.

3. The method of claim 1, wherein the error information comprises a number of correctable errors that occur over a predetermined period of time and are attributable to the electrical components.

4. The method of claim 3, wherein the method further comprises:
determining that the number of correctable errors that occur over the predetermined period of time exceeds a threshold number; and
increasing, by the microcontroller based on the determining, the regulated output voltage output by one or more of the voltage regulators.

5. The method of claim 1, wherein the microcontroller individually adjusts the regulated output voltages based on one or both of a lookup table and an artificial intelligence (AI) model.

6. The method of claim 5, wherein the AI model increases scores for voltage alterations that do not increase correctable errors and decreases scores for voltage alterations that increase correctable errors.

7. The method of claim 1, wherein the circuit board is an input/output (I/O) card of a computing system.

8. The method of claim 1, wherein the environmental information includes temperature information and humidity information.

9. The method of claim 1, wherein the electrical components are Peripheral Component Interconnect Express (PCIe) components, and include one or more of an optical module component, a retimer component, and a switch component.

10. A computer system comprising:
a processor set;
a circuit board including a plurality of voltage regulators to output regulated output voltages to a plurality of electrical components on the circuit board;
one or more computer-readable storage media; and
program instructions stored on the one or more storage media to cause the processor set to perform operations comprising:
receiving environmental information and error information; and
individually adjusting, based on the environmental information and the error information, the regulated output voltages output by the voltage regulators.

11. The computer system of claim 10, wherein the operations further comprise:
receiving component utilization information; and
individually adjusting, based on the environmental information, the error information, and the component utilization information, the regulated output voltages output by the voltage regulators.

12. The computer system of claim 10, wherein the error information comprises a number of correctable errors that occur over a predetermined period of time and are attributable to the electrical components.

13. The computer system of claim 12, wherein the operations further comprise:
determining that the number of correctable errors that occur over the predetermined period of time exceeds a threshold number; and
increasing, based on the determining, the regulated output voltage output by one or more of the voltage regulators.

14. The computer system of claim 10, wherein the regulated output voltages are individually adjusted based on one or both of a lookup table and an artificial intelligence (AI) model.

15. The computer system of claim 14, wherein the AI model increases scores for voltage alterations that do not increase correctable errors and decreases scores for voltage alterations that increase correctable errors.

16. The computer system of claim 10, wherein the circuit board is an input/output (I/O) card of the computer system.

17. The computer system of claim 10, wherein the environmental information includes temperature information and humidity information.

18. The computer system of claim 10, wherein the electrical components are Peripheral Component Interconnect Express (PCIe) components, and include one or more of an optical module component, a retimer component, and a switch component.

19. A computer program product comprising:
one or more computer-readable storage media; and
program instructions stored on the one or more storage media to perform operations comprising:
controlling a plurality of voltage regulators on a circuit board to output a plurality of regulated output voltages to a plurality of electrical components on the circuit board;
receiving environmental information and error information; and
individually adjusting, based on the environmental information and the error information, the regulated output voltages output by the voltage regulators.

20. The computer program product of claim 19, wherein the operations further comprise:
receiving component utilization information; and
individually adjusting, based on the environmental information, the error information, and the component utilization information, the regulated output voltages output by the voltage regulators.
